(19) United States
(12) Patent Application Publication
(10) Pub. No.: US 2012/0268456 A1
(43) Pub. Date: Oct. 25, 2012

(54) INFORMATION PROCESSOR, INFORMATION PROCESSING METHOD, AND COMPUTER PROGRAM PRODUCT

(76) Inventor: HIDETOSHI YOKOI, Tokyo (JP)

(21) Appl. No.: 13/365,974

(22) Filed: Feb. 3, 2012

(30) Foreign Application Priority Data
Apr. 19, 2011 (JP) 2011-093287

(51) Int. Cl. G06T 15/00; G09G 5/00

(52) U.S. Cl. 345/419

(57) ABSTRACT

According to one embodiment, an information processor includes: a display module; and a display changing module. The display module is configured to two-dimensionally display or three-dimensionally display each of a plurality of regions set on a screen. The display changing module is configured to change, if a three-dimensionally displayed first display region and a two-dimensionally displayed second display region overlaps each other and a state of the first display region satisfies a predetermined condition, the first display region to be displayed two-dimensionally.

### CROSS-REFERENCE TO RELATED APPLICATIONS

This application is based upon and claims the benefit of priority from Japanese Patent Application No. 2011-093287, filed Apr. 19, 2011, the entire contents of which are incorporated herein by reference.

### FIELD

Embodiments described herein relate generally to an information processor, an information processing method, and a computer program product.

### BACKGROUND

Conventionally, a technique relating to an image display device that displays both a two-dimensional image and a three-dimensional image has been disclosed. In the image display device, a display region on which a three-dimensional image is displayed is set on a part of a display screen and an image processing is performed on the display region such that three-dimensional display is performed thereon.

However, in the conventional technique, if a part of another window or the like on which a two-dimensional image is displayed is overlapped with the display region on which a three-dimensional image is displayed, the display of the three-dimensional image is destroyed and the three-dimensional image cannot be displayed appropriately.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of an information processor according to an embodiment;

FIG. 2 is an exemplary block diagram of a hardware configuration of the information processor in the embodiment;

FIG. 3 is an exemplary block diagram of a functional configuration of the information processor in the embodiment;

FIG. 4 is an exemplary view of a window display region displayed on an LCD if a three-dimensional display mode is started, in the embodiment;

FIG. 5 is an exemplary view of if another display region 62 overlaps a front face of the window display region in the three-dimensional display mode, in the embodiment;

FIG. 6 is an exemplary view of the window display region if switched to a two-dimensional display mode, in the embodiment; and

FIG. 7 is an exemplary flowchart of a display processing performed by the information processor, in the embodiment.

### DETAILED DESCRIPTION

In general, according to one embodiment, an information processor comprises: a display module; and a display changing module. The display module is configured to two-dimensionally display or three-dimensionally display each of a plurality of regions set on a screen. The display changing module is configured to change, if a three-dimensionally displayed first display region and a two-dimensionally displayed second display region overlaps each other and a state of the first display region satisfies a predetermined condition, the first display region to be displayed two-dimensionally.

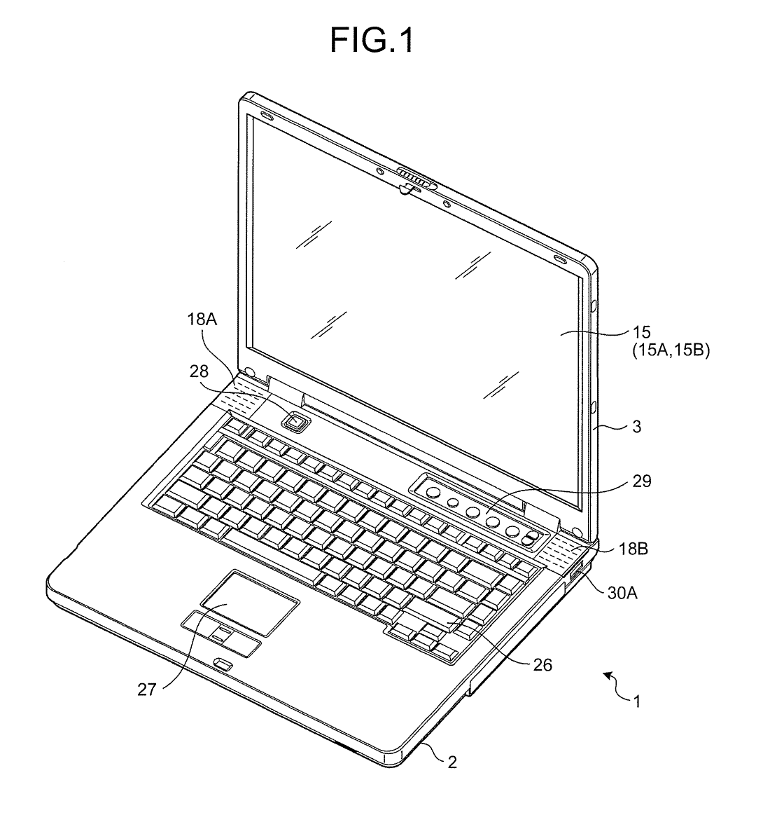

FIG. 1 is an external perspective view of an information processor 1 according to an embodiment. In the embodiment, a case is described where the information processor 1 is used as a notebook personal computer (PC). It is to be noted that the information processor 1 is not limited to the notebook PC. As other examples, a television receiver, a recorder for storing video data (for example, a hard disk drive (HDD) recorder, a digital versatile disk (DVD: registered trademark) recorder, a Blu-ray (BD: registered trademark) recorder), a tablet PC, a slate PC, a personal digital assistant (PDA), a car navigation system, a smart phone, or the like may be used as the information processor according to the embodiment.

As illustrated in FIG. 1, the information processor 1 comprises a main body 2 and a display unit 3 provided on the main body 2 so as to be opened and closed.

A three-dimensional display (3D display) 15 is incorporated into the display unit 3. The 3D display 15 performs three-dimensional display by a naked eye stereoscopic system (for example, integral imaging system, lenticular system, parallax barrier system). The 3D display 15 comprises a liquid crystal display (LCD) 15A and a lens unit 15B that is arranged on the LCD 15A.

The lens unit 15B comprises a plurality of lens mechanisms for emitting a plurality of light beams corresponding to a plurality of pixels contained in a video that is displayed on the LCD 15A in predetermined directions. The lens unit 15B is a liquid crystal gradient index (GRIN) lens that can electrically switch functions necessary for three-dimensional video display, for example. In the liquid crystal GRIN lens, a refractive index distribution is created on an electrode by using a flat liquid crystal layer. Therefore, the liquid crystal GRIN lens makes it possible to perform three-dimensional display on a specified region on a screen and perform two-dimensional display on the other region, for example.

A keyboard 26, a power button 28, an operation panel 29, a touch pad 27, speakers 18A, 18B, and the like are arranged on an upper face of the main body 2. Various operation buttons for controlling TV functions (viewing and listening, recording, and reproduction of recorded broadcast program data/video data) are provided on the operation panel 29.

An antenna terminal 30A for TV broadcasting is provided on a side face of the main body 2. Furthermore, an external display connection terminal (not illustrated) corresponding to a high-definition multimedia interface (HDMI) standard, for example, is provided on a rear face of the main body 2. The external display connection terminal is used for outputting video data (moving image data) contained in video content data such as broadcast program data to an external display.

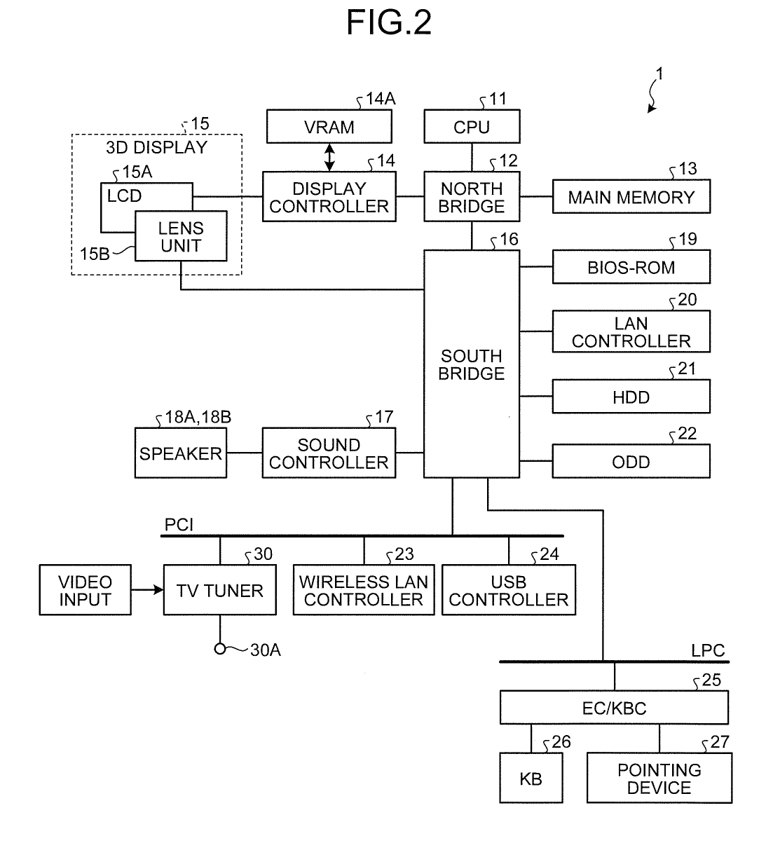

Next, a hardware configuration comprised in the main body 2 is described. FIG. 2 is a block diagram illustrating a hardware configuration of the information processor 1.

As illustrated in FIG. 2, the information processor 1 comprises: a CPU 11; a north bridge 12; a main memory 13; a display controller 14; a video random access memory (VRAM: video RAM) 14A; the 3D display 15; a south bridge 16; a sound controller 17; the speakers 18A, 18B; a basic input/output system read only memory (BIOS-ROM) 19; a local area network (LAN) controller 20; a hard disk drive (HDD) 21; an optical disk drive (ODD) 22; a wireless LAN controller 23; a universal serial bus (USB) controller 24; an embedded controller/keyboard controller (EC/KBC) 25; the keyboard (KB) 26; the touch pad 27; and a TV tuner 30; and the like.

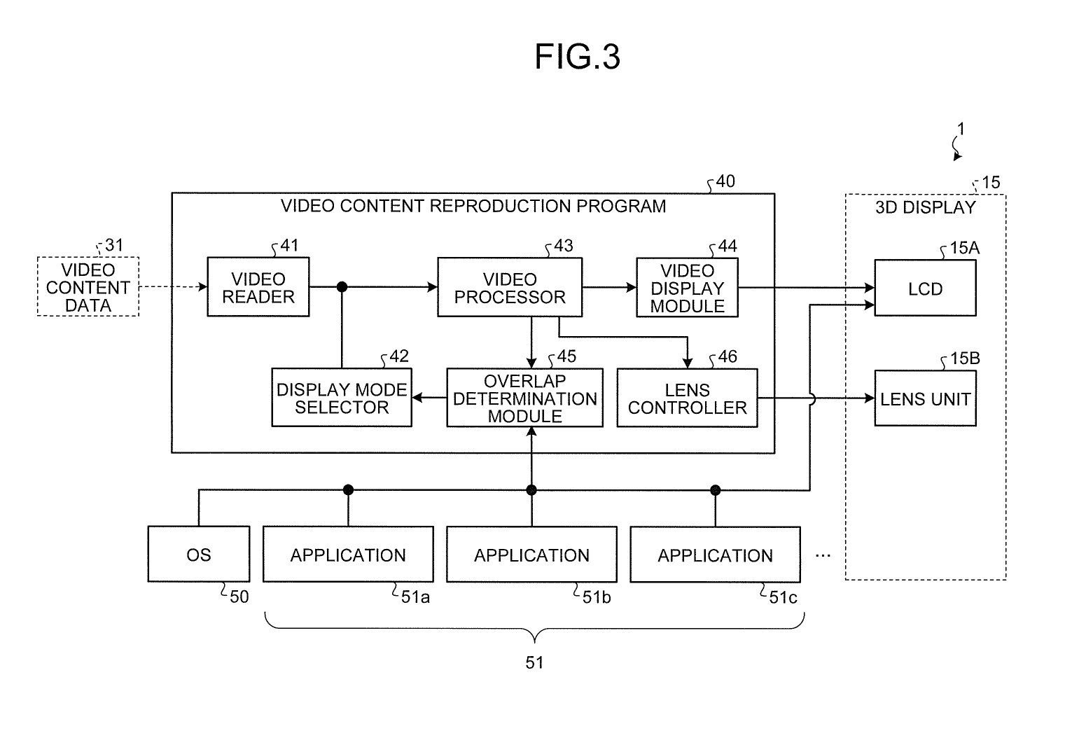

The BIOS-ROM 19 stores a basic input/output system (BIOS) . The HDD 21 stores an operating system (OS) 50 (see, FIG. 3), a video content reproduction program 40 (see, FIG. 3) for viewing and listening video content data and other various applications 51 (see, FIG. 3) . Details of the video content reproduction program 40 will be described later.

The north bridge 12 is a bridge device that connects between a local bus of the CPU 11 and the south bridge 16. A memory controller that controls access to the main memory 13 is incorporated in the north bridge 12. Furthermore, the north bridge 12 has a function of executing communication with the display controller 14.

The display controller 14 is a device that controls the LCD 15A. The LCD 15A receives a display signal generated by the display controller 14 and displays a video (image) based on the display signal. It is to be noted that the video to be displayed may be a moving image or a still image.

The south bridge 16 controls each device on a peripheral component interconnect (PCI) bus and a low pin count (LPC) bus. Furthermore, the south bridge 16 incorporates an Integrated Drive Electronics (IDE) controller for controlling the HDD 21 and the ODD 22 and a memory controller for controlling access to the BIOS-ROM 19. In addition, the south bridge 16 has a function of executing communication with the sound controller 17 and the LAN controller 20.

Furthermore, the south bridge 16 outputs a control signal to the lens unit 15B. The control signal is a signal for controlling each of a plurality of regions in the lens unit 15B to be set to either a three-dimensional display mode or a two-dimensional display mode in accordance with a request by the video content reproduction program 40, or the like.

The lens unit 15B is switched between the three-dimensional display mode for performing the three-dimensional display and the two-dimensional display mode for performing the two-dimensional display. To be more specific, the lens unit 15B is switched therebetween by changing refractive indexes of the liquid crystal GRIN lens between a region on which the three-dimensional display is performed and a region on which the two-dimensional display is performed in accordance with the control signal output by the south bridge 16.

On the region set to the three-dimensional display mode, the refractive index of the liquid crystal GRIN lens is changed such that a three dimensional video containing a video for a left eye and a video for a right eye to be displayed on the region has a parallax in accordance with a distance between the eyes, a viewing distance, and the like. On the region set to the two-dimensional display mode, the refractive index of the liquid crystal GRIN lens is set such that the two-dimensional video to be displayed on the region is displayed as it is, without being refracted. With this, each display region having an arbitrary position and size, which is set on a screen of the 3D display 15, can be set to either the three-dimensional display mode or the two-dimensional display mode.

The 3D display 15 performs the three-dimensional display by displaying the video for the left eye and the video for the right eye on the region in the three-dimensional display mode and performs the two-dimensional display on the region in the two-dimensional display mode. Therefore, a user can perceive a three-dimensional video when the user views the region set in the three-dimensional display mode on the screen. On the other hand, the user can perceive a two-dimensional video when the user views the region set in the two-dimensional display mode on the screen. In such a manner, the information processor 1 can partially perform the three-dimensional display and the two-dimensional display on the screen displayed on the LCD 15A so as to display both the two-dimensional display and the three-dimensional display.

The sound controller 17 is a sound source device, and outputs audio data to be reproduced to the speakers 18A, 18B. The LAN controller 20 is a wired communication device that executes wired communication of an Ethernet (registered trademark) standard, for example. The wireless LAN controller 23 is a wireless communication device that executes wireless communication of an IEEE 802.11 standard, for example. Furthermore, the USE controller 24 executes communication with an external device through a cable of a USB2.0 standard, for example.

The EC/KBC 25 is a single chip micro computer in which an embedded controller for performing electrical management, the keyboard (KB) 26, and a keyboard controller for controlling the touch pad 27 are integrated. The EC/KBC 25 has a function of turning ON/OFF the power of the information processor 1 in accordance with an operation of a user.

The TV tuner 30 is a receiver that receives broadcast program data broadcasted by a television (TV) broadcast signal, and is connected to the antenna terminal 30A (see, FIG. 1). It is needless to say that the TV tuner 30 may receive the TV broadcast signal using an incorporated antenna. The TV tuner 30 is realized as a digital TV tuner that can receive data of a digital broadcast program such as digital terrestrial television broadcasting. Furthermore, the TV tuner 30 also has a function of capturing video data input from an external device.

The CPU 11 is a processor that controls an operation of the information processor 1. The CPU 11 loads various types of programs, such as the video content reproduction program 40, the OS 50, and other applications 51 (51a, 51b, 51c, . . . ) that are stored in the HDD 21, onto the main memory 13, and executes the programs (see, FIG. 3). Furthermore, the CPU 11 loads the BIOS stored in the BIOS-ROM 19 onto the main memory 13, and executes the BIOS.

Next, a functional configuration of the information processor 1 is described. FIG. 3 is a block diagram illustrating an example of a functional configuration of the information processor 1.

As illustrated in FIG. 3, the video content reproduction program 40 has a module configuration comprising a video reader 41, a display mode selector 42, a video processor 43, a video display module 44, an overlap determination module 45, a lens controller 46, and the like. The CPU 11 (processor) reads out the video content reproduction program 40 from the HDD 21 and executes the video content reproduction program 40. With this, the above-mentioned modules are loaded onto the main memory 13, so that the video reader 41, the display mode selector 42, the video processor 43, the video display module 44, the overlap determination module 45, the lens controller 46, and the like are generated on a main storage device.

The video content reproduction program 40 executed by the information processor 1 according to the embodiment is recorded and provided in a recording medium that can be read by a computer, such as a CD-ROM, a flexible disk (FD), a CD-R, and a digital versatile disk (DVD), and provided. Here, the video content reproduction program 40 is recorded in the recording medium in an installable/executable file format.

Furthermore, the video content reproduction program 40 executed by the information processor 1 according to the embodiment may be stored in a computer connected to a network such as the Internet, and provided through the network by download. Alternatively, the video content reproduction program 40 executed by the information processor 1 according to the embodiment may be provided or distributed through a network such as the Internet. In addition, the video content reproduction program 40 according to the embodiment may be provided by being previously incorporated in a ROM or the like.

The video reader 41 reads video content data 31 through the south bridge 16, and outputs the video content data 31 to the video processor 43.

The video content data 31 comprises broadcast program data received by the TV tuner 30, broadcast program data/video data recorded in a recording medium such as a DVD and a BD or a recording device such as the HDD 21, and content data received through a network.

The video content data 31 comprises various types of metadata, two-dimensional video data or three-dimensional video data. It is to be noted that each of the two-dimensional video data and the three-dimensional video data may be either of a moving image and a still image, and may or may not contain voice data.

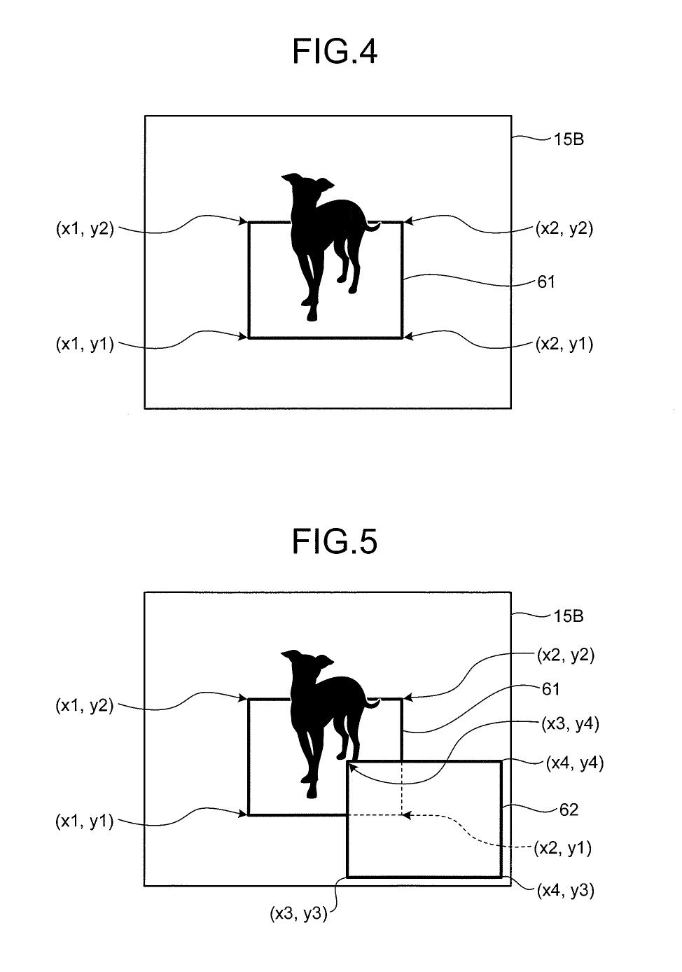

The display mode selector 42 selects a display mode if the video content data 31 is displayed on a window display region 61 (see, FIG. 4) of the LCD 15A. It is to be noted that as the display mode, either the two-dimensional display mode in which the video content data 31 is two-dimensionally displayed or the three-dimensional display mode in which the video content data 31 is three-dimensionally displayed can be selected.

FIG. 4 is a view illustrating an example of the window display region 61 that is displayed on the LCD 15A. As illustrated in FIG. 4, the window display region 61 (first display region) is at least a part of the LCD 15A and is a display region of a window on which a video or the like based on the video content data 31 is displayed. It is to be noted that in FIG. 4, an example in which the video content data 31 is three-dimensionally displayed on the window display region 61 is illustrated.

The display mode selector 42 receives a selection instruction (or switching instruction) to perform the two-dimensional display or the three-dimensional display based on a selection operation by a user. Furthermore, the display mode selector 42 selects a display mode of the window display region 61 based on a display method that has been instructed and received and a determination result of the overlap determination module 45, which will be described later.

To be more specific, the display mode selector 42 displays an operation screen on which the two-dimensional display or the three-dimensional display is selected on the LCD 15A. If the two-dimensional display is selected on the operation screen, the display mode selector 42 selects the two-dimensional display mode and starts the two-dimensional display processing of the video content data. Furthermore, if the three-dimensional display is selected on the operation screen, the display mode selector 42 selects a display mode of the window display region 61 in accordance with the determination result of the overlap determination module 45, which will be described later.

It is to be noted that the display mode selector 42 may determine that the three-dimensional display is selected if the video content data 31 contains three-dimensional video data, and determine that the two-dimensional display is selected if the video content data 31 does not contain the three-dimensional video data.

The video processor 43 performs various processings such as an image processing on the video content data 31, generates video data in a display mode selected by the display mode selector 42, and outputs the generated video data to the video display module 44.

That is to say, if the three-dimensional display mode is selected and the video content data 31 contains the three-dimensional video data, the video processor 43 generates video data for the left eye and video data for the right eye to be displayed on the window display region 61 using the three-dimensional video data so as to correspond to coordinates of the window display region 61. In this case, the video processor 43 generates the video data for the left eye and the video data for the right eye based on a binocular parallax, a viewing distance, and the like. Then, the video processor 43 outputs the video data for the left eye and the video data for the right eye to be displayed on the window display region 61 to the video display module 44.

On the other hand, if the three-dimensional display mode is selected and the video content data 31 contains the two-dimensional video data, the video processor 43 performs 2D-to-3D conversion on the two-dimensional video data to generate three-dimensional video data. That is to say, by the 2D-to-3D conversion, a plurality of depth values corresponding to a plurality of pixels contained in each image frame whithin the two-dimensional video is estimated, and a plurality of parallaxes corresponding to the estimated depth values are calculated based on the binocular parallaxes, the viewing distances, and the like. That is to say, the parallaxes corresponding to the pixels contained in the image frame are calculated. The video processor 43 generates video data for the left eye and video data for the right eye to be displayed on the window display region 61 based on the calculated parallaxes so as to correspond to coordinates of the window display region 61. Then, the video processor 43 outputs the generated video data for the left eye and the generated video data for the right eye to be displayed on the window display region 61 to the video display module 44.

If the two-dimensional display mode is selected and the video content data 31 contains the two-dimensional video data, the video processor 43 generates two-dimensional video data to be displayed on the window display region 61 so as to correspond to coordinates of the window display region 61. Then, the video processor 43 outputs the generated two-dimensional video data to be displayed on the window display region 61 to the video display module 44.

If the two-dimensional display mode is selected and the video content data 31 contains the three-dimensional video data, the video processor 43 performs 3D-to-2D conversion on the three-dimensional video data to generate two-dimensional video data to be displayed on the window display region 61. As an example, the video processor 43 generates the two-dimensional video data to be displayed on the window display region 61 using either of the video data for the left eye or the video data for the right eye that are contained in the three-dimensional video data. Then, the video processor 43 outputs the generated two-dimensional video data to be displayed on the window display region 61 to the video display module 44.

The video processor 43 further outputs coordinate information of the window display region 61, and information indicating a display mode of the window display region 61 to the lens controller 46. For example, the video processor 43 outputs the coordinate information (for example, x: x1 to x2, y: y1 to y2) of the window display region 61 and an instruction to display the display region in the three-dimensional display mode to the lens controller 46 if the three-dimensional display mode is started.

The lens controller 46 controls the lens unit 15B based on the coordinate information and the instruction that are input from the video processor 43 so as to switch the video display mode of the window display region 61 to the two-dimensional display mode or the three-dimensional display mode.

That is to say, if an instruction to display in the three-dimensional display mode is input, the lens controller 46 applies voltages in accordance with respective coordinates to a portion corresponding to the window display region 61 in the lens unit 15B so as to control respective parts in the lens unit 15B to have refractive indexes corresponding to the respective coordinates. On the other hand, if an instruction to display in the two-dimensional display mode is input, the lens controller 46 does not apply a voltage to the portion corresponding to the window display region 61 in the lens unit 15B so as to control the two-dimensional video not to be polarized.

The video display module 44 displays a video on the window display region 61 of the LCD 15A based on the video data input from the video processor 43.

That is, in the case of the three-dimensional display mode, the video for the left eye and the video for the right eye are displayed on the window display region 61 in the LCD 15A by using the video data for the left eye and the video data for the right eye that are input from the video processor 43. A light emitting direction of each pixel on the video for the left eye and the video for the right eye displayed in this manner is controlled by a portion corresponding to the window display region 61 in the lens unit 15B. Therefore, a user can sterically perceive the video with naked eyes.

On the other hand, in case of the two-dimensional display mode, the two-dimensional video is displayed on the window display region 61 in the LCD 15A by using the two-dimensional video data input from the video processor 43.

In this manner, the video display module 44 and the like perform the two-dimensional display or the three-dimensional display on each of a plurality of regions (for example, window display region 61, another display region 62) set on the screen of the LCD 15A.

Next, a case is described where a window such as a dialog box is displayed at a front side with respect to the window display region 61 by the OS 50 or the applications 51.

FIG. 5 is a view illustrating a case where another display region 62 (second display region) overlaps a front face of the window display region 61 in the three-dimensional display mode. Note that the second display region 62 comprises a display region on which the two-dimensional display is performed, such as a window and a dialog box displayed by the OS 50 and the other applications 51. Examples of the dialog box include a window providing an error message and a window informing incoming of a mail.

As described above, in the three-dimensional display mode, a refractive index on the window display region 61 is changed by the lens controller 46. Accordingly, the second display region 62 is not two-dimensionally displayed appropriately on the window display region 61 (x: x1 to x2, y: y1 to y2). Therefore, display on a region (x: x3 to x2, y: y1 to y4) on which the window display region 61 and the second display region 62 overlap each other is disturbed in the example of FIG. 5.

Then, the information processor 1 according to the embodiment detects that the second display region 62 overlaps the front face of the window display region 61 in the three-dimensional display mode as described above. If the overlapping is detected, the information processor 1 changes the display mode of the window display region 61 from the three-dimensional mode to the two-dimensional mode.

The overlap determination module 45 determines whether the window display region 61 on which the three-dimensional display is performed and at least a part of the second display region 62 overlap each other based on coordinate information of the window display region 61 and coordinate information of the second display region 62. Note that the coordinate information of the window display region 61 is acquired from the video processor 43 and the coordinate information of the second display region 62 is acquired from the OS 50 or the other applications 51.

Furthermore, the overlap determination module 45 determines whether a state corresponding to the window display region 61 on which the three-dimensional display is performed becomes a predetermined state. Note that the predetermined state indicates a state where the second display region 62 is located at the front side with respect to the window display region 61, for example. The overlap determination module 45 determines whether the second display region 62 is located at the front side with respect to the window display region 61.

Then, if the overlap determination module 45 determines that the window display region 61 on which the three-dimensional display is performed overlaps at least a part of the second display region 62 and determines that the second display region 62 is located at the front side with respect to the window display region 61, the display mode selector 42 changes the display mode of the window display region 61 from the three-dimensional display mode to the two-dimensional display mode.

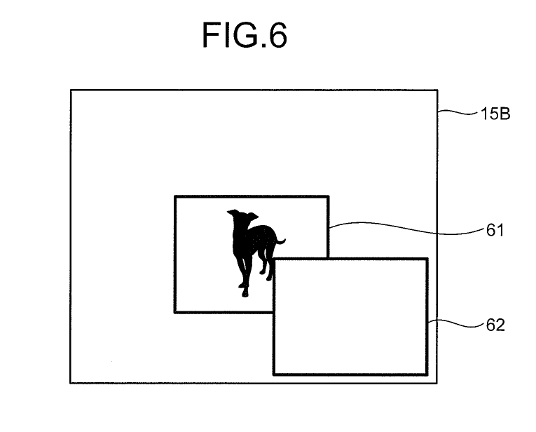

FIG. 6 is a view illustrating the window display region 61 when switched to the two-dimensional display mode. If the display mode selector 42 switches the display mode of the window display region 61 from the three-dimensional display mode to the two-dimensional display mode as described above, the 3D display 15 switches the video on the window display region 61 to the two-dimensional display, and displays it.

For example, the video processor 43 performs the 3D-to-2D conversion on the three-dimensional video data contained in the video content data 31 to generate the two-dimensional video data to be displayed on the window display region 61. Then, the video processor 43 outputs the generated two-dimensional video data to be displayed on the window display region 61 to the video display module 44. Furthermore, the video processor 43 outputs the coordinate information (for example, x: x1 to x2, y: y1 to y2) of the window display region 61 and the instruction to display the display region in the two-dimensional display mode to the lens controller 46. The lens controller 46 cancels the voltage application to the portion corresponding to the window display region 61 (x: x1 to x2, y: y1 to y2) of the lens unit 15B so as to control the two-dimensional video not to be polarized. Furthermore, the video display module 44 two-dimensionally displays a video of the video content data 31 on the window display region 61 of the LCD 15A based on the video data input from the video processor 43.

As described above, the display mode selector 42, the video processor 43, the video display module 44, and the lens controller 46 function as display changing modules that change the three-dimensional display on the three-dimensional display region to the two-dimensional display.

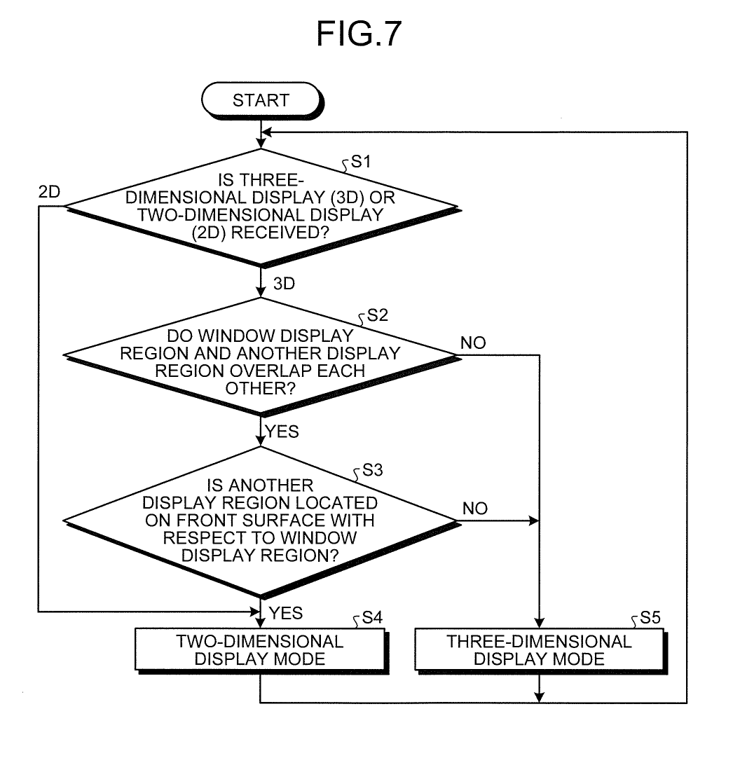

Next, the display processing performed by the information processor 1 is explained. FIG. 7 is a flowchart of the display processing performed by the information processor 1.

At first, the video reader 41 reads the video content data 31 onto the main memory 13. Furthermore, it is determined whether the selection instruction to perform the three-dimensional display (3D) is received or the selection instruction to perform the two-dimensional display (2D) is received on the operation screen (S1).

If the selection instruction to perform the two-dimensional display is received (2D at S1), the display mode selector 42 starts a display processing of the video content data 31 in the two-dimensional display mode (S4). Thereafter, the process proceeds to S1 and it is determined whether a switching selection to the three-dimensional display is received. The video is continued to be displayed in the two-dimensional display mode while the switching selection to the three-dimensional display is not received (2D at S1) (S4).

On the other hand, if the selection instruction to perform the three-dimensional display is received (3D at S1), the overlap determination module 45 determines whether the window display region 61 as a display region of the video content data 31 and the second display region 62 overlaps each other (S2). If the overlap determination module 45 determines that the windows does not overlap each other (No at S2), the display mode selector 42 starts the video display in the three-dimensional display mode (S5) and the process proceeds to S1.

If the overlap determination module 45 determines that the windows overlap each other with the display of the window display region 61 (Yes at S2), the overlap determination module 45 further determines whether the second display region 62 is located at the front side with respect to the window display region 61 (S3). If the window display region 61 is newly displayed, the window display region 61 is always displayed so as to be located at the front-most side. Therefore, the second display region 62 is not located at the front side with respect to the window display region 61 (No at S3). Accordingly, the display mode selector 42 starts video display in the three-dimensional display mode (S5) and the process proceeds to S1.

Then, the determination at S1 is again performed. If the switching instruction to the two-dimensional display is not received and the three-dimensional display is still selected (3D at S1), the process proceeds to S2. Then, the overlap determination module 45 determines whether the window display region 61 and the second display region 62 overlap each other (S2). If it is determined that the windows do not overlap each other (No at S2), the video display in the three-dimensional display mode is continued (S5). Thereafter, the process proceeds to S1 again.

At S2, if it is determined that the window display region 61 and the second display region 62 overlap each other (Yes at S2), the overlap determination module 45 further detemrines whether the second display region 62 is located at the front side with respect to the window display region 61 (S3). If the window display region 61 is located at the front side with respect to the second display region 62 (No at S3), the video display in the three-dimensional display mode is continued (S5). Thereafter, the process proceeds to S1 again.

On the other hand, if the second display region 62 is located at the front side with respect to the window display region 61 (Yes at S3), the display mode selector 42 starts video display in the two-dimensional display mode (S4). Thereafter, returning to S1, the display mode selector 42 determines whether the selection operation of switching to the two-dimensional display is received from a user (S1). If the three-dimensional display is still selected and the selection of switching to the two-dimensional display is not received (3D at S1), the overlap determination module 45 determines whether the overlapping of the window display region 61 and the second display region 62 with respect to each other is removed (S2 to S3).

If the overlapping is removed (No at S2 or No at S3), the display mode selector 42 brings back the display mode of the window display region 61 to the three-dimensional display mode and performs video display (S5). Then, back to S1 and it is determined whether the selection instruction to switch to the two-dimensional display is received. Subsequently, the above-mentioned processes are repeated.

The overlap determination module 45 can perform determination at S2, S3 every predetermined time by repeating the above-mentioned processes.

It is to be noted that the timing of the overlap determination is not limited to the above-mentioned timings at S2, S3. As another example, the overlap determination module 45 may perform overlap determination (S2 to S3) corresponding to the window display region 61 if the second display region 62 pops up. Alternatively, the overlap determination module 45 may perform the overlap determination (S2 to S3) corresponding to the window display region 61 if the second display region 62 is dragged (for example, at the timing at which the drag operation is started).

Furthermore, in the above description, the overlap determination module 45 determines whether the window display region 61 is located at the front side with respect to the second display region 62. However, the overlap determination module 45 may determine other conditions. For example, the overlap determination module 45 may determine whether the window display region 61 is active. If the overlap determination module 45 determines that the window display region 61 is inactive, the display mode selector 42 may switch the display mode of the window display region 61 from the three-dimensional display mode to the two-dimensional display mode.

Furthermore, in the above description, the video content reproduction program 40 has functions of the display mode selector 42 and the overlap determination module 45. However, the OS 50 may have the functions of the display mode selector 42 and the overlap determination module 45. In this case, the OS 50 determines whether the windows overlap each other based on the coordinate information relating to the window display region 61 acquired from the video content reproduction program 40 and the second display region 62 acquired from the other application 51. Furthermore, the display mode selector 42 outputs the information indicating the display mode and the coordinate information of the window display region 61 to the video processor 43 of the video content reproduction program 40.

Furthermore, described above is a case where the three-dimensional display is performed by the naked eye stereoscopic system. However, the embodiment may be applied to an information processor in which the three-dimensional display is performed by an active shutter system using glasses.

It is to be noted that the timing at which the overlap determination of the window display region 61 and the second display region 62 is performed is not particularly limited. As an example, whether the window display region 61 and the second display region 62 overlap each other may be previously determined at a timing immediately before at least one of the window display region 61 and the second display region 62 is displayed or at a timing at which a display position of at least one of the window display region 61 and the second display region 62 is changed.

As described above, according to the embodiment, if the first display region on which the three-dimensional display is performed and the second display region on which the two-dimensional display is performed overlap each other and the state of the first display region satisfies the predetermined condition, the first display region is changed to be displayed two-dimensionally. In this manner, if another display overlaps the three-dimensional display, the three-dimensional display is switched to the two-dimensional display. Therefore, the three-dimensional display and the two-dimensional display can be displayed without being interfered with each other. Accordingly, if both the two-dimensional image and the three-dimensional image are displayed, the three-dimensional image can be prevented from being disturbed.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a display module configured to two-dimensionally display or three-dimensionally display each of a plurality of regions set on a screen; and
a display changing module configured to change, if a three-dimensionally displayed first display region and a two-dimensionally displayed second display region overlaps each other and a state of the first display region satisfies a predetermined condition, the first display region to be displayed two-dimensionally.

2. The information processor of claim 1, wherein, if the second display region is located at a front side with respect to the first display region, the display changing module changes the first display region to be displayed two-dimensionally.

3. The information processor of claim 1, wherein, if the first display region is inactive, the display changing module changes the first display region to be displayed two-dimensionally.

4. The information processor of claim 1, further comprising: a determination module configured to determine whether the three-dimensionally displayed first display region and the two-dimensionally displayed second display region overlaps each other and a state of the first display region satisfies the predetermined condition, wherein
the display changing module is configured to change the first display region to be displayed two-dimensionally based on a determination result by the determination module.

5. The information processor of claim 4, wherein the determination module performs the determination corresponding to the first display region if the second display region pops up.

6. The information processor of claim 4, wherein the determination module performs the determination corresponding to the first display region if the second display region is dragged.

7. The information processor of claim 1, wherein the display changing module is configured to change the two-dimensionally displayed first display region to be displayed three-dimensionally if the second display region does not overlap the two-dimensionally displayed first display region.

8. The information processor of claim 1, further comprising:
a display device;
a lens provided on the display device, a refractive index of the lens being changeable; and
a lens controller configured to control the refractive index of the lens so as to correspond to a display coordinate of the display device, wherein
the display changing module is configured to change the three-dimensionally displayed first display region to be displayed two-dimensionally by changing the refractive index of the lens corresponding to the first display region by the lens controller.

9. An information processing method that is executed in an information processor, the information processing method comprising:
two-dimensionally display or three-dimensionally display each of a plurality of regions set on a screen; and,
if a three-dimensionally displayed first display region and a two-dimensionally displayed second display region overlaps each other and a state of the first display region satisfies a predetermined condition, the first display region to be displayed two-dimensionally.

10. A computer program product having a non-transitory computer readable medium including programmed instructions, wherein the instructions, when executed by a computer, cause the computer to perform:
two-dimensionally display or three-dimensionally display each of a plurality of regions set on a screen; and,
if a three-dimensionally displayed first display region and a two-dimensionally displayed second display region overlaps each other and a state of the first display region satisfies a predetermined condition, the first display region to be displayed two-dimensionally.
